(19) United States
(12) Patent Application Publication
(10) Pub. No.: US 2026/0148636 A1
(43) Pub. Date: May 28, 2026

(54) DYNAMIC LOCAL ENSEMBLE GENERATION FOR AUTONOMOUS VEHICLE ARTIFICIAL INTELLIGENCE AGENTS

(71) Applicant: AUTOBRAINS TECHNOLOGIES LTD, Tel Aviv-Yafo (IL)

(72) Inventor: Igal RAICHELGAUZ, Tel Aviv (IL)

(73) Assignee: AUTOBRAINS TECHNOLOGIES LTD, Tel Aviv-Yafo (IL)

(21) Appl. No.: 19/403,099

(22) Filed: Nov. 27, 2025

Related U.S. Application Data
(63) Continuation-in-part of application No. 18/914,860, filed on Oct. 14, 2024.
(60) Provisional application No. 63/903,241, filed on Oct. 22, 2025.

(51) Int. Cl. G08G 1/0967; G06N 20/20

(52) U.S. Cl. CPC G08G 1/096725; G06N 20/20

(57) ABSTRACT

The present disclosure provides a method for agentic artificial intelligence agents based driving of an autonomous vehicle. For each location along a driving path: (a) the autonomous vehicle receives from a remote system a local ensemble associated with the environment, the local ensemble comprises narrow artificial intelligence agents and a router that selects agents based on environmental information, (b) feeding the ensemble sensed environmental information, (c) identifying the scenario faced by the vehicle, (d) selecting relevant narrow artificial intelligence agents for that scenario, (e) sending sensed information to selected agents, generating driving decisions by the agents, and (f) executing autonomous driving operations based on those decisions.

### CROSS-REFERENCE TO RELATED APPLICATIONS

This application is a continuation-in-part of U.S. application Ser. No. 18/914,860, titled “ENHANCEMENT OF AI MODELS FOR AUTONOMOUS DRIVING PER LOCALIZATION”, filed Oct. 14, 2024, which is hereby incorporated by reference in its entirety.

### FIELD OF INVENTION

The present disclosure relates to autonomous vehicle control systems, and more particularly to dynamic generation of location-specific artificial intelligence agent ensembles for autonomous vehicle driving operations.

### BACKGROUND

Autonomous vehicles rely on sophisticated artificial intelligence systems to navigate complex driving environments and make real-time decisions. These systems typically employ various machine learning models and algorithms to process sensor data, interpret traffic scenarios, and generate appropriate driving responses. The computational demands of autonomous driving applications present ongoing challenges in balancing processing capabilities with the constraints of vehicle-based computing resources.

Traditional autonomous vehicle architectures often utilize centralized artificial intelligence systems that attempt to handle all possible driving scenarios through comprehensive models. However, the diversity of driving environments, from urban intersections to highway merging zones, presents varying computational and decision-making requirements. Different locations along a driving route may encounter distinct traffic patterns, road geometries, and environmental conditions that could benefit from specialized processing approaches.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

According to an aspect of the present disclosure, a method for agentic artificial intelligence agents based driving of an autonomous vehicle is provided. Method comprises, for each location of multiple locations being passed by the autonomous vehicle that follows a driving path, receiving, from a remote computerized system and by a computerized unit of the autonomous vehicle, a local ensemble that is associated with an environment of the autonomous vehicle once the autonomous vehicle is located at the location. The receiving of the local ensemble occurs before the autonomous vehicle reaches the location. The local ensemble comprises narrow artificial intelligence agents related to the environment and a router configured to select one or more of the narrow artificial intelligence agents based on at least information regarding the environment. Method further comprises feeding the local ensemble with sensed information regarding the environment. Method comprises identifying, by the router and based on the sensed information, a scenario faced by the autonomous vehicle. Method comprises selecting, by the router, one or more selected narrow artificial intelligence agents associated with the scenario. Method comprises sending the sensed information to the one or more selected narrow artificial intelligence agents. Method comprises generating, by the one or more selected narrow artificial intelligence agents, one or more driving related decision. Method comprises triggering an execution of one or more autonomous driving operations based on the one or more driving related decision.

According to other aspects of the present disclosure, method may include one or more of the following features. Each local ensemble may comprise a fraction of narrow artificial intelligence agents accessible to the remote computerized system during the driving session. The router may have selection capabilities that are a fraction of overall selection capabilities required to select between the narrow artificial intelligence agents accessible to the remote computerized system during the driving session. Method may further comprise receiving a default ensemble, and selecting to generate the one or more driving related decision by the default ensemble when a local ensemble compatible to any of the locations is not accessible. Method may further comprise predicting an occurrence of a future miscommunication with the remote computerized system, and sending a future miscommunication indication to the remote computerized system. The narrow artificial intelligence agents may be related to the environment by being trained to generate driving related decisions regarding scenarios expected to be faced by the autonomous vehicle within the environment. At least some of the multiple locations may be spaced apart by tens of meters from each other. Method may further comprise removing from a memory unit of the vehicle the local ensemble of the location after the vehicle passed the location. The narrow artificial intelligence agents may comprise end to end narrow artificial intelligence agents. The narrow artificial intelligence agents may comprise one or more narrow artificial intelligence agents distilled from one or more reference narrow artificial intelligence agents that are larger than the one or more narrow artificial intelligence agents.

According to another aspect of the present disclosure, a non-transitory computer-readable medium storing instructions is provided. When executed by a processor of an autonomous vehicle, the instructions cause the processor to perform operations comprising, for each location of multiple locations being passed by the autonomous vehicle that follows a driving path, receiving, from a remote computerized system and by a computerized unit of the autonomous vehicle, a local ensemble that is associated with an environment of the autonomous vehicle once the autonomous vehicle is located at the location. The receiving of the local ensemble occurs before the autonomous vehicle reaches the location. The local ensemble comprises narrow artificial intelligence agents related to the environment and a router configured to select one or more of the narrow artificial intelligence agents based on at least information regarding the environment. The operations further comprise feeding the local ensemble with sensed information regarding the environment. The operations comprise identifying, by the router and based on the sensed information, a scenario faced by the autonomous vehicle. The operations comprise selecting, by the router, one or more selected narrow artificial intelligence agents associated with the scenario. The operations comprise sending the sensed information to the one or more selected narrow artificial intelligence agents. The operations comprise generating, by the one or more selected narrow artificial intelligence agents, one or more driving related decision. The operations comprise triggering an execution of one or more autonomous driving operations based on the one or more driving related decision.

According to other aspects of the present disclosure, the non-transitory computer-readable medium may include one or more of the following features. Each local ensemble may comprise a fraction of narrow artificial intelligence agents accessible to the remote computerized system during the driving session. The router may have selection capabilities that are a fraction of overall selection capabilities required to select between the narrow artificial intelligence agents accessible to the remote computerized system during the driving session. The operations may further comprise receiving a default ensemble, and selecting to generate the one or more driving related decision by the default ensemble when a local ensemble compatible to any of the locations is not accessible. The operations may further comprise predicting an occurrence of a future miscommunication with the remote computerized system, and sending a future miscommunication indication to the remote computerized system. The narrow artificial intelligence agents may be related to the environment by being trained to generate driving related decisions regarding scenarios expected to be faced by the autonomous vehicle within the environment. At least some of the multiple locations may be spaced apart by tens of meters from each other. The operations may further comprise removing from a memory unit of the vehicle the local ensemble of the location after the vehicle passed the location. The narrow artificial intelligence agents may comprise end to end narrow artificial intelligence agents. The narrow artificial intelligence agents may comprise one or more narrow artificial intelligence agents distilled from one or more reference narrow artificial intelligence agents that are larger than the one or more narrow artificial intelligence agents.

The foregoing general description of the illustrative embodiments and the following detailed description thereof are merely exemplary aspects of the teachings of this disclosure and are not restrictive.

### BRIEF DESCRIPTION OF FIGURES

Non-limiting and non-exhaustive examples are described with reference to the following figures.

FIG. 1 illustrates a flowchart for a method for agentic artificial intelligence agents based driving of an autonomous vehicle, according to aspects of the present disclosure.

FIG. 2 depicts a map illustrating a planned driving path with multiple locations for local ensemble deployment, according to aspects of the present disclosure.

FIG. 3 depicts the map of FIG. 2 including optional locations representing deviations from the planned driving path, according to aspects of the present disclosure.

FIG. 4 illustrates a system architecture for location-based local ensemble deployment in an autonomous vehicle, according to aspects of the present disclosure.

FIG. 5 illustrates a hierarchical representation of optional local ensembles for autonomous vehicle driving operations, according to aspects of the present disclosure.

FIG. 6 illustrates a global ensemble, according to aspects of the present disclosure.

FIG. 7 illustrates a block diagram of a computerized system configured to communicate with autonomous vehicles, according to aspects of the present disclosure.

FIG. 8 illustrates a block diagram of the autonomous vehicle incorporating various interconnected systems for autonomous driving operations, according to aspects of the present disclosure.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

The deployment of artificial intelligence agents in autonomous vehicles involves considerations of computational efficiency, memory utilization, and real-time performance requirements. Vehicle-based computing systems face limitations in processing power, storage capacity, and energy consumption compared to cloud-based computational resources. These constraints influence the design and implementation of artificial intelligence systems for autonomous driving applications.

Remote computational resources offer expanded processing capabilities that can support more sophisticated artificial intelligence operations than those feasible on vehicle-based systems. However, the integration of remote and local computational resources presents challenges related to communication latency, network connectivity, and data transmission requirements. The coordination between cloud-based and vehicle-based artificial intelligence systems involves balancing computational distribution with real-time operational demands.

The field continues to explore approaches for optimizing artificial intelligence system architectures in autonomous vehicles, including methods for managing computational resources, coordinating multiple artificial intelligence agents, and adapting system behavior to varying operational conditions. These developments aim to enhance the performance and efficiency of autonomous driving systems while addressing the practical constraints of vehicle-based implementations.

According to another aspect of the present disclosure, the term “local” as used in the context of local ensembles may refer to a region or area of relatively small size. In some cases, the local region may have a length that ranges between a few meters to a few tens of meters, or a few hundred meters. The local region may have a length that does not exceed 1 kilometer, 5 kilometers, or 10 kilometers. In urban scenarios, the area or region may be smaller compared to highway or rural environments. The term “few” as used herein may refer to a quantity between one and ten.

The local ensembles may be tailored to these geographically constrained regions to provide specialized artificial intelligence capabilities that are optimized for the specific environmental conditions, traffic patterns, and infrastructure characteristics encountered within each local area. In some aspects, the size of the local region may be determined based on factors including road complexity, traffic density, environmental variability, and computational resource considerations. Urban local regions may encompass smaller geographic areas due to the higher density of traffic scenarios and more frequent changes in environmental conditions compared to highway or rural settings.

The local ensemble deployment may be coordinated with the autonomous vehicle's position tracking systems to ensure that appropriate artificial intelligence resources are activated when the vehicle enters each local region. In some cases, the boundaries of local regions may be defined based on significant changes in driving conditions, infrastructure characteristics, or expected traffic scenarios that warrant specialized artificial intelligence agent selection and processing capabilities. The vehicle position tracking system may use air2road technology which provides lane level localization by matching between aerial signature and image-view signature. An example of vehicle position tracking system is illustrated in U.S. patent application Ser. No. 18/527,701 Titled ZERO SHOT LOCALIZATION FOR AUTONOMOUS DRIVING (attorney docket number AB-32) which is incorporated herein by reference.

According to another aspect of the present disclosure, the narrow artificial intelligence agents may be implemented as modular architectures that comprise separate specialized components for different aspects of autonomous driving operations. The narrow artificial intelligence agents may include perception-focused agents that specialize in processing sensor data to identify and classify environmental elements including vehicles, pedestrians, traffic signs, road markings, and obstacles. In some cases, the narrow artificial intelligence agents may comprise prediction-focused agents that analyze identified environmental elements to forecast future states, trajectories, and behaviors of traffic participants and dynamic objects within the driving environment.

The narrow artificial intelligence agents may include planning-focused agents that generate trajectory plans, path selections, and driving strategies based on current environmental conditions and predicted future states. In some aspects, the narrow artificial intelligence agents may comprise control-focused agents that convert planned trajectories and driving strategies into specific vehicle control commands including steering angles, acceleration values, braking forces, and gear selections. The modular architecture may enable each narrow artificial intelligence agent to specialize in particular aspects of the autonomous driving pipeline while maintaining coordination with other agents within the local ensemble.

The narrow artificial intelligence agents may include scenario-specific agents that are trained to handle particular driving situations including intersection navigation, highway merging, parking maneuvers, construction zone navigation, and emergency vehicle response. In some cases, the narrow artificial intelligence agents may comprise weather-specific agents that are optimized for driving operations under particular environmental conditions including rain, snow, fog, or bright sunlight. The narrow artificial intelligence agents may include traffic-density-specific agents that are tailored for different traffic conditions including heavy congestion, light traffic, or stop-and-go scenarios.

The narrow artificial intelligence agents may comprise road-type-specific agents that specialize in particular infrastructure configurations including urban streets, highways, rural roads, or complex intersections. In some aspects, the narrow artificial intelligence agents may include time-of-day-specific agents that are optimized for driving operations during different periods including rush hour traffic, nighttime conditions, or weekend travel patterns. The narrow artificial intelligence agents may comprise speed-specific agents that are designed for particular velocity ranges including low-speed maneuvering, highway cruising, or variable speed operations.

The narrow artificial intelligence agents may include path-planning agents that generate optimal routes through detected environments. In some cases, the narrow artificial intelligence agents may include lane-keeping agents that maintain proper lane positioning, following-distance agents that manage spacing relative to other vehicles, and signal-recognition agents that interpret traffic control devices and road signage.

Examples of narrow artificial intelligence agents and/or ensembles are illustrated in U.S. patent application Ser. No. 18/459,423 (Attorney reference number AB-12) filing date Sep. 1, 2023, U.S. provisional patent Ser. No. 18/036,150 (Attorney reference number COR-283) filing date May 9, 2023, U.S. patent application Ser. No. 18/800,477 (Attorney reference number AB-72-US), filing date Aug. 12, 2024, U.S. patent application Ser. No. 18/822,285 (Attorney reference number AB-78-US), filing date Sep. 2, 2024—all being incorporated herein by reference.

According to another aspect of the present disclosure, the narrow artificial intelligence agents may be distilled from reference narrow artificial intelligence agents through various model compression and optimization techniques. The distillation process may employ structured channel pruning to systematically remove redundant or less significant channels from neural network architectures, thereby reducing computational complexity while preserving decision-making capabilities. In some cases, the structured channel pruning may analyze channel importance scores based on gradient information, activation patterns, or weight magnitudes to identify channels that contribute minimally to overall model performance.

The distillation process may incorporate quantization techniques that reduce the numerical precision of model parameters and activations from higher precision formats to lower precision representations. The quantization may convert floating-point weights and activations to fixed-point representations, such as 8-bit or 16-bit integers, enabling more efficient storage and computation while maintaining acceptable performance levels. In some aspects, the quantization process may employ post-training quantization methods that calibrate quantization parameters using representative data samples, or quantization-aware training approaches that incorporate quantization effects during the training process.

Knowledge distillation may be utilized to transfer learned knowledge from larger reference narrow artificial intelligence agents to smaller distilled versions. The knowledge distillation process may involve training the smaller narrow artificial intelligence agents to mimic the output distributions, intermediate feature representations, or decision-making patterns of the larger reference agents. In some cases, the knowledge distillation may employ temperature scaling to soften the output probability distributions of the reference agents, enabling the smaller agents to learn from the nuanced decision boundaries and uncertainty estimates of the larger models.

The distillation process may apply low-rank decomposition techniques to decompose weight matrices within the narrow artificial intelligence agents into products of lower-rank matrices. The low-rank decomposition may utilize singular value decomposition, matrix factorization, or tensor decomposition methods to approximate high-dimensional weight matrices with combinations of smaller matrices. In some aspects, the low-rank decomposition may be applied selectively to specific layers or components within the narrow artificial intelligence agents based on computational bottleneck analysis and performance impact assessment.

Model graph optimization may be performed to streamline the computational graph structure of the narrow artificial intelligence agents by eliminating redundant operations, fusing compatible operations, and optimizing data flow patterns. The model graph optimization may include operator fusion techniques that combine multiple sequential operations into single optimized kernels, constant folding to pre-compute static values, and dead code elimination to remove unused computational paths. In some cases, the model graph optimization may reorganize memory access patterns and data layouts to improve cache efficiency and reduce memory bandwidth requirements during inference operations.

The distillation process may combine multiple compression techniques in a coordinated manner to achieve optimal trade-offs between model size, computational efficiency, and performance accuracy. The combination of techniques may be applied iteratively, with each compression method building upon the results of previous optimization steps. In some aspects, the distillation process may employ automated neural architecture search methods to identify optimal combinations of compression techniques and hyperparameters for specific deployment constraints and performance requirements.

According to another aspect of the present disclosure, the distillation outcome may be determined based on communication parameters that influence the transmission and deployment of narrow artificial intelligence agents to autonomous vehicles. The size of the distilled narrow artificial intelligence agents may be adjusted based on available bandwidth, network latency, signal strength, and connection stability between the remote computerized system and the autonomous vehicle. In some cases, when communication parameters indicate limited bandwidth or unstable connectivity, the distillation process may generate smaller narrow artificial intelligence agents that can be transmitted more efficiently while maintaining acceptable performance levels for autonomous driving operations.

The distillation outcome may be influenced by the danger or risk level associated with the autonomous vehicle's current or anticipated driving environment. Higher risk scenarios may warrant larger narrow artificial intelligence agents that possess enhanced decision-making capabilities and more comprehensive processing resources to address complex or hazardous driving situations. In some aspects, the risk assessment may consider factors including traffic density, weather conditions, road complexity, construction zones, emergency situations, and proximity to vulnerable road users such as pedestrians or cyclists.

The size determination process may evaluate real-time risk indicators to dynamically adjust the computational complexity and memory requirements of narrow artificial intelligence agents deployed to the autonomous vehicle. When the autonomous vehicle approaches high-risk environments including busy intersections, highway merging zones, or areas with poor visibility conditions, the distillation process may generate larger narrow artificial intelligence agents with expanded neural network architectures and increased parameter counts. In some cases, the larger agents may incorporate additional layers, wider network structures, or ensemble components that provide enhanced accuracy and robustness for critical decision-making scenarios.

The risk-based sizing may consider temporal factors that influence the likelihood of encountering dangerous situations during autonomous vehicle operation. Rush hour traffic conditions, nighttime driving, or adverse weather events may trigger the deployment of larger narrow artificial intelligence agents that possess specialized capabilities for handling challenging driving scenarios. In some aspects, the distillation process may maintain libraries of pre-computed narrow artificial intelligence agents at different size levels, enabling rapid selection and deployment based on current risk assessments and communication constraints.

The communication parameter evaluation may incorporate predictive analysis of network conditions to anticipate future connectivity challenges and adjust distillation outcomes accordingly. When the autonomous vehicle approaches areas with known communication limitations, the distillation process may generate appropriately sized narrow artificial intelligence agents that can be transmitted successfully before connectivity degrades. In some cases, the size optimization may balance the trade-off between agent capability and transmission feasibility to ensure continuous availability of artificial intelligence resources throughout the driving session.

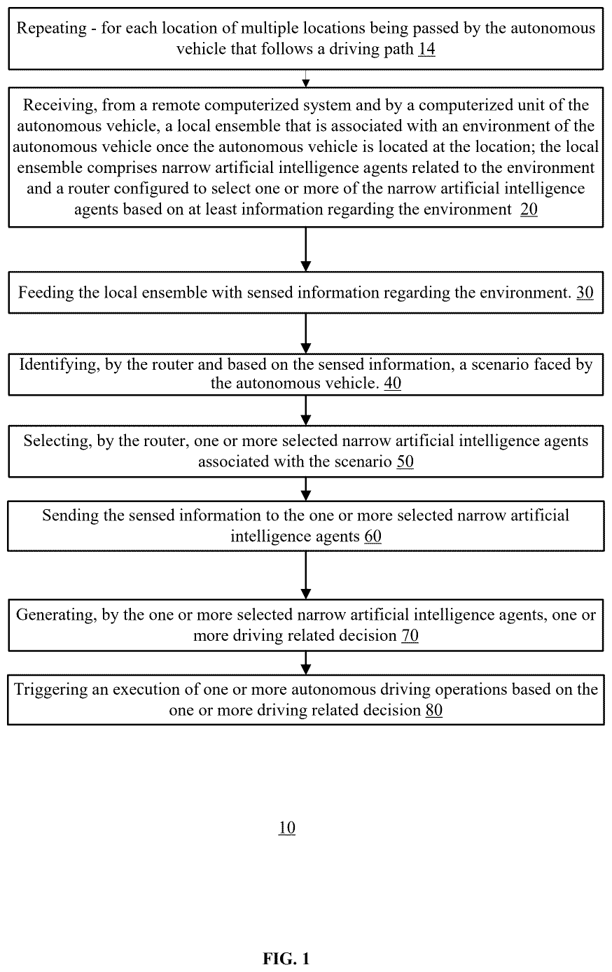

Referring to FIG. 1, a method 10 for agentic artificial intelligence agents based driving of an autonomous vehicle may be implemented to provide location-specific artificial intelligence capabilities along a driving path.

Method 10 may include step 14 of repeating for each location of multiple locations being passed by the autonomous vehicle that follows a driving path. Within this repeating process, method 10 may proceed through a sequence of operations (for example steps 20, 30, 40, 50, 60, 70 and 80) that enable the autonomous vehicle to receive and utilize specialized artificial intelligence ensembles tailored to specific environmental conditions and scenarios.

Method 10 may include step 20 of receiving, from a remote computerized system and by a computerized unit of the autonomous vehicle, a local ensemble that is associated with an environment of the autonomous vehicle once the autonomous vehicle is located at the location. The receiving of the local ensemble occurs before the autonomous vehicle reaches the location. The local ensemble may comprise narrow artificial intelligence agents related to the environment and a router configured to select one or more of the narrow artificial intelligence agents based on at least information regarding the environment. In some cases, the local ensemble provides a subset of artificial intelligence capabilities that are specifically tailored to the environmental conditions and expected scenarios at each particular location along the driving path.

The sending of the local ensembles may be performed in a periodic manner according to predetermined time intervals, or may be triggered based on specific events including route changes, traffic condition updates, or environmental state transitions. The transmission of local ensembles may occur at least a defined period before the autonomous vehicle reaches the relevant locations, enabling sufficient processing time for ensemble deployment and initialization.

The timing of local ensemble transmission may be based on communication conditions between the remote computerized system and the autonomous vehicle, with the remote computerized system monitoring signal strength, data transmission rates, network latency, and connection stability to determine optimal transmission windows. When communication issues are predicted, the remote computerized system may transmit local ensembles in bursts during periods of stable connectivity.

Preloading multiple ensembles to ensure continued autonomous driving capabilities during anticipated communication disruptions. The frequency of local ensemble transmission may be adjusted based on the complexity of scenes encountered by the autonomous vehicle, with more frequent transmissions occurring when the difference between scenes in current locations and next locations exceeds predetermined complexity thresholds. Method may include estimating communication conditions by analyzing environmental factors, with dense urban environments typically experiencing reduced signal strength and increased interference compared to rural or highway environments outside of city areas. The communication condition estimation may incorporate factors including building density, terrain characteristics, network infrastructure availability, and historical connectivity data to predict communication reliability and adjust ensemble transmission strategies accordingly.

The deployment of location-specific local ensembles including specialized perception routers may provide enhanced accuracy and efficiency compared to utilizing a single global perception router stored within the autonomous vehicle. The local perception routers may be tailored to specific environmental conditions, traffic patterns, and infrastructure characteristics encountered at particular locations along the driving path, enabling more precise scenario identification and agent selection processes. In some cases, the location-specific training and optimization of local perception routers may result in improved recognition accuracy for environmental features, traffic participants, and driving scenarios that are characteristic of specific geographic areas or road configurations.

According to an embodiment, a local perception router is a lightweight, location-specific component responsible for identifying the driving scenario and routing sensor data to the most suitable narrow AI agents. Because each router is crafted for known scenario types and the specific region in which it operates, it only needs to distinguish among a small set of local environmental conditions. This targeted design allows the router to be implemented, in some implementations, as a compact neural-network classifier optimized for rapid scenario identification; in other implementations, as a rule-based mechanism that applies deterministic logic tailored to the region; or as a decision-tree or gradient-boosted model that provides fast, interpretable routing. These implementations may also be combined, for example by using a neural classifier whose output is refined by rule-based checks or tree-based logic.

A local perception router is a local adapted version of perception router illustrated in of U.S. patent application Ser. No. 17/093,442 titled “ENSEMBLE OF NARROW AI AGENTS” filing date Sep. 11, 2020 which is incorporated herein by reference.

The local perception routers may exhibit reduced computational complexity compared to comprehensive global perception systems, as each local router may be designed to handle a subset of scenarios and environmental conditions relevant to its designated location. This reduced complexity may translate to lower power consumption during operation, as the local perception routers may require fewer computational resources and memory accesses to perform their specialized routing functions. In some aspects, the power efficiency gains from deploying lightweight local perception routers may contribute to extended operational range and reduced energy consumption for autonomous vehicle systems.

The local perception routers may be configured to manage a significantly smaller scope of decision-making responsibilities compared to global perception systems. In some cases, each local perception router may be designed to handle less than 5 percent of the routing decisions required by a comprehensive global perception router. The scope reduction may be even more substantial, with local perception routers potentially managing less than 1 percent, 0.1 percent, 0.01 percent, 0.001 percent, 0.0001 percent, or 0.000001 percent of the global perception router's decision-making capabilities. This dramatic reduction in scope may enable highly optimized and efficient routing operations that are specifically tuned for the environmental conditions and expected scenarios at each location.

Similarly, the deployment of location-specific decision units within local ensembles may provide advantages over utilizing a single global decision unit stored within the autonomous vehicle. The local decision units may be optimized for the specific types of driving decisions and control commands that are most relevant to their designated locations, enabling more efficient processing and potentially improved decision quality. The local decision units may incorporate specialized algorithms and processing routines that are tailored to the narrow artificial intelligence agents and environmental conditions associated with specific locations, potentially resulting in faster decision generation and reduced computational overhead.

The local decision units may also exhibit reduced power consumption compared to comprehensive global decision systems, as they may be designed to handle a limited subset of decision-making scenarios and output formats. In some aspects, the specialized nature of local decision units may enable more efficient memory utilization and reduced processing complexity, contributing to overall system efficiency and energy conservation. The combination of location-specific perception routers and decision units within local ensembles may provide a distributed approach to autonomous driving intelligence that balances computational efficiency with specialized performance optimization for diverse driving environments.

The local ensembles may exhibit reduced size and lower power consumption compared to comprehensive global artificial intelligence systems, as each local ensemble may be designed to contain only the narrow artificial intelligence agents and processing components necessary for the specific environmental conditions and scenarios anticipated at particular locations. The smaller size of local ensembles may enable more efficient storage utilization within the autonomous vehicle's memory systems and may reduce the computational overhead associated with loading, initializing, and managing artificial intelligence resources during real-time driving operations.

The reduced power consumption characteristics of local ensembles may result from their focused scope and specialized functionality, as the narrow artificial intelligence agents within each ensemble may be optimized for specific scenarios rather than maintaining comprehensive capabilities across all possible driving situations. In some cases, the power efficiency gains may be particularly significant during extended driving sessions, where the cumulative energy savings from deploying smaller, specialized ensembles may contribute to improved overall vehicle efficiency and extended operational range.

The smaller size of local ensembles may facilitate more comprehensive validation and testing processes compared to large-scale global artificial intelligence systems. The reduced complexity and focused scope of each local ensemble may enable more thorough testing coverage, as validation procedures may examine all possible interactions and decision pathways within the ensemble more systematically. In some aspects, the ability to validate local ensembles as complete, self-contained units may provide enhanced confidence in their reliability and performance characteristics for specific environmental conditions and driving scenarios.

The validation advantages of smaller local ensembles may include more efficient regression testing, where changes or updates to individual ensembles may be tested more comprehensively without requiring validation of extensive global system interactions. The focused nature of local ensembles may enable targeted testing scenarios that specifically address the environmental conditions and driving situations relevant to each ensemble's designated location. In some cases, the smaller ensemble size may facilitate more rapid validation cycles and may enable more frequent updates and improvements to location-specific artificial intelligence capabilities while maintaining rigorous testing standards.

The communication between the autonomous vehicle and the remote computerized system may be implemented using indirect communication paths that provide alternative connectivity options when direct communication channels are unavailable or degraded. In some cases, the communication may utilize vehicle-to-vehicle communication protocols that enable the autonomous vehicle to exchange data with other vehicles in the vicinity, creating a mesh network of connected vehicles that can relay information between the autonomous vehicle and the remote computerized system. The other vehicles may serve as communication intermediaries, receiving local ensembles from the remote computerized system and forwarding these ensembles to the autonomous vehicle when direct communication is not feasible.

The indirect communication paths may include multi-hop communication scenarios where data transmission occurs through a series of intermediate vehicles, with each vehicle in the communication chain receiving and retransmitting information until it reaches the intended destination. In some aspects, the autonomous vehicle may communicate with nearby vehicles that maintain stronger connectivity to the remote computerized system, enabling the autonomous vehicle to access cloud-based artificial intelligence resources through these proxy connections. The vehicle-to-vehicle communication may utilize dedicated short-range communication protocols, cellular vehicle-to-everything communication standards, or other wireless communication technologies that enable reliable data exchange between vehicles.

The remote computerized system may coordinate with multiple vehicles simultaneously to establish redundant communication pathways that ensure local ensemble delivery even when individual communication links experience disruptions. In some cases, the remote computerized system may distribute local ensembles to multiple vehicles in a geographic area, enabling any of these vehicles to serve as a local cache or relay point for other vehicles that require the same location-specific artificial intelligence resources. The indirect communication approach may provide improved communication reliability in challenging environments including urban canyons, tunnels, or remote areas where direct connectivity to the remote computerized system may be limited or intermittent.

Following the receipt of the local ensemble, method 10 may advance to step 30 of feeding the local ensemble with sensed information regarding the environment. The sensed information may include data collected from various sensors of the autonomous vehicle that capture environmental conditions, road infrastructure, traffic participants, and other relevant factors that influence autonomous driving operations.

Method 10 may then proceed to step 40 of identifying, by the local perception router and based on the sensed information, a scenario faced by the autonomous vehicle. The local perception router may analyze the sensed information to determine the specific driving scenario or situation that the autonomous vehicle encounters at the current location.

Method 10 may continue with step 50 of selecting, by the local perception router, one or more selected narrow artificial intelligence agents associated with the scenario. The local perception router may evaluate the identified scenario and determine which narrow artificial intelligence agents within the local ensemble are most suitable for addressing the specific driving situation. Subsequently, method 10 may proceed to step 60 of sending the sensed information to the one or more selected narrow artificial intelligence agents. The selected narrow artificial intelligence agents may receive the sensed information and process the data according to their specialized training and capabilities.

Method 10 may then advance to step 70 of generating, by the one or more selected narrow artificial intelligence agents, one or more driving related decision. The narrow artificial intelligence agents may analyze the sensed information and generate decisions that address the specific scenario faced by the autonomous vehicle. These driving related decisions may be compliant with specific autonomous driving levels including L2, L2+, L2++, L3, or L4 autonomous driving standards, ensuring that the decisions align with established autonomous driving capabilities and safety requirements.

The driving related decisions may control at least one of speed, velocity, and direction of progress of the autonomous vehicle autonomously. In some cases, the driving related decisions may include speed control commands that adjust the vehicle's velocity based on traffic conditions, road infrastructure, and safety requirements encountered at specific locations along the driving path. The speed control may involve acceleration commands that increase vehicle velocity when entering highway on-ramps or merging into faster-moving traffic streams, or deceleration commands that reduce vehicle speed when approaching intersections, construction zones, or areas with reduced speed limits.

The driving related decisions may include velocity modulation commands that provide fine-grained control over the vehicle's rate of movement in response to dynamic traffic scenarios. In some aspects, velocity modulation may involve gradual speed adjustments that maintain safe following distances behind preceding vehicles, smooth velocity transitions when changing lanes in dense traffic conditions, or precise speed matching when merging with traffic flows at highway interchanges. The velocity control may incorporate predictive adjustments that anticipate upcoming traffic conditions based on sensor data and location-specific intelligence provided by the narrow artificial intelligence agents.

The driving related decisions may include directional control commands that govern the autonomous vehicle's steering and path selection operations. The directional control may involve lane-keeping commands that maintain proper vehicle positioning within designated travel lanes, lane-change commands that execute safe transitions between adjacent lanes when overtaking slower vehicles or preparing for upcoming turns, and turning commands that navigate the vehicle through intersections, roundabouts, or highway interchanges. In some cases, the directional control may include evasive maneuvering commands that steer the vehicle around obstacles, construction barriers, or emergency vehicles while maintaining safe clearance distances.

The driving related decisions may generate specific control commands for various road scenarios encountered during autonomous vehicle operation. In urban intersection scenarios, the decisions may include stop commands that bring the vehicle to a complete halt at red traffic signals or stop signs, proceed commands that advance the vehicle through intersections when traffic signals indicate safe passage, and yield commands that allow the vehicle to wait for pedestrians or cross-traffic to clear before proceeding. The intersection control may involve precise timing adjustments that coordinate vehicle movement with traffic signal phases and pedestrian crossing cycles.

In highway merging scenarios, the driving related decisions may include acceleration commands that increase vehicle speed to match the velocity of highway traffic streams, gap-selection commands that identify suitable spaces between vehicles for safe merging, and steering commands that guide the vehicle through the merging maneuver while maintaining appropriate spacing from adjacent vehicles. The merging control may incorporate predictive analysis of traffic flow patterns and vehicle trajectories to execute smooth integration into highway traffic.

In parking scenarios, the driving related decisions may include low-speed maneuvering commands that control precise vehicle positioning during parallel parking, perpendicular parking, or angle parking operations. The parking control may involve reverse commands that back the vehicle into parking spaces, forward commands that position the vehicle within designated parking boundaries, and steering commands that align the vehicle properly within parking space markings. In some aspects, the parking decisions may include multi-point turning commands that execute complex maneuvering sequences in confined parking areas.

In construction zone scenarios, the driving related decisions may include speed reduction commands that comply with temporary speed limits posted in work areas, lane-shift commands that guide the vehicle through temporary traffic patterns created by construction barriers, and following-distance commands that maintain increased spacing behind construction vehicles or other traffic navigating through work zones. The construction zone control may involve enhanced caution protocols that reduce vehicle speed and increase reaction times when operating near construction equipment or workers.

Finally, method 10 may proceed to step 80 of triggering an execution of one or more autonomous driving operations based on the one or more driving related decision. The driving related decisions may be directed to specific vehicle components including brakes, clutch, engine, gear, or other components that control velocity, acceleration, and direction of movement of the autonomous vehicle. In some cases, the driving related decisions may be converted to control signals or instructions that directly interface with the vehicle's control systems to execute the determined autonomous driving operations.

Method 10 may be implemented as instructions stored on a non-transitory computer-readable medium that, when executed by a processor of an autonomous vehicle, cause the processor to perform the operations described above. The non-transitory computer-readable medium may store software modules and algorithms that enable the autonomous vehicle to receive local ensembles, process sensed information, select appropriate narrow artificial intelligence agents, generate driving related decisions, and trigger autonomous driving operations in accordance with method 10.

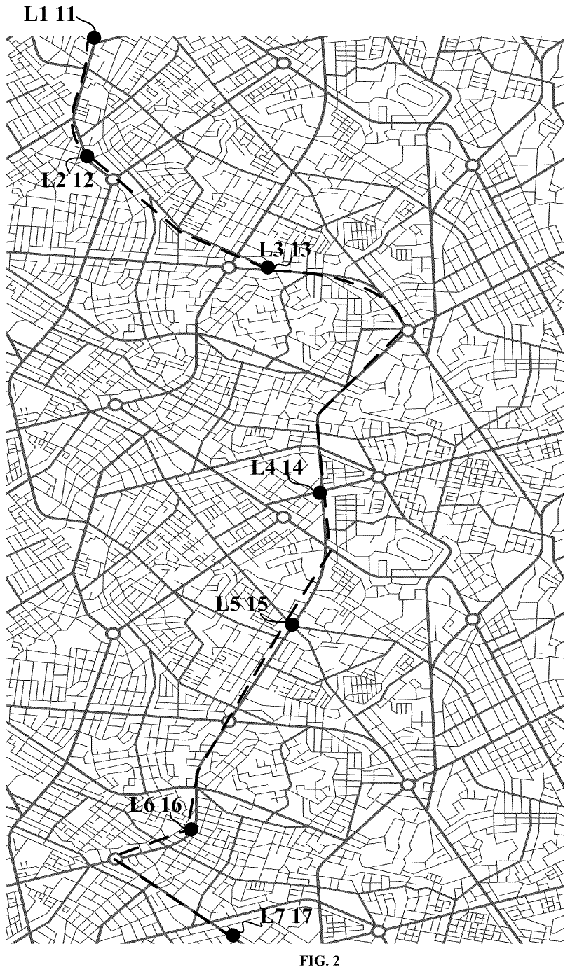

Referring to FIG. 2, a map illustrates a planned driving path with multiple locations where different local ensembles may be deployed for autonomous vehicle operations. The map shows a first location L1 marked with a first location identifier I1, positioned at an initial point along the driving path. A second location L2 may be marked with a second location identifier 12, positioned sequentially along the driving path from the first location L1. The driving path may continue to a third location L3 marked with a third location identifier 13, followed by a fourth location L4 marked with a fourth location identifier I4.

The planned driving path may further include a fifth location L5 marked with a fifth location identifier 15, a sixth location L6 marked with a sixth location identifier 16, and a seventh location L7 marked with a seventh location identifier 17. The locations may be distributed sequentially along the driving path, with the first location L1 positioned at an upper region of the map and the seventh location L7 positioned at a lower region of the map. Each location identifier may provide a unique designation for the corresponding location, enabling the autonomous vehicle and remote computerized system to coordinate the deployment of appropriate local ensembles.

The spatial distribution of the locations along the driving path may be configured to provide comprehensive coverage of the autonomous vehicle's journey while maintaining computational efficiency. In some cases, at least some of the multiple locations are spaced apart by tens of meters from each other, allowing the autonomous vehicle to receive location-specific artificial intelligence capabilities at regular intervals along the driving path. The spacing between locations may be determined based on factors including environmental changes, road infrastructure variations, traffic density patterns, and computational resource considerations.

The driving path may traverse through various street networks and road configurations, as represented by the background infrastructure shown in the map. Each of the first location L1 through the seventh location L7 may correspond to specific environmental conditions and expected driving scenarios that warrant specialized narrow artificial intelligence agents. The location identifiers I1 through 17 may facilitate communication between the autonomous vehicle and the remote computerized system, enabling the system to determine which local ensemble should be transmitted to the autonomous vehicle at each specific location along the planned driving path.

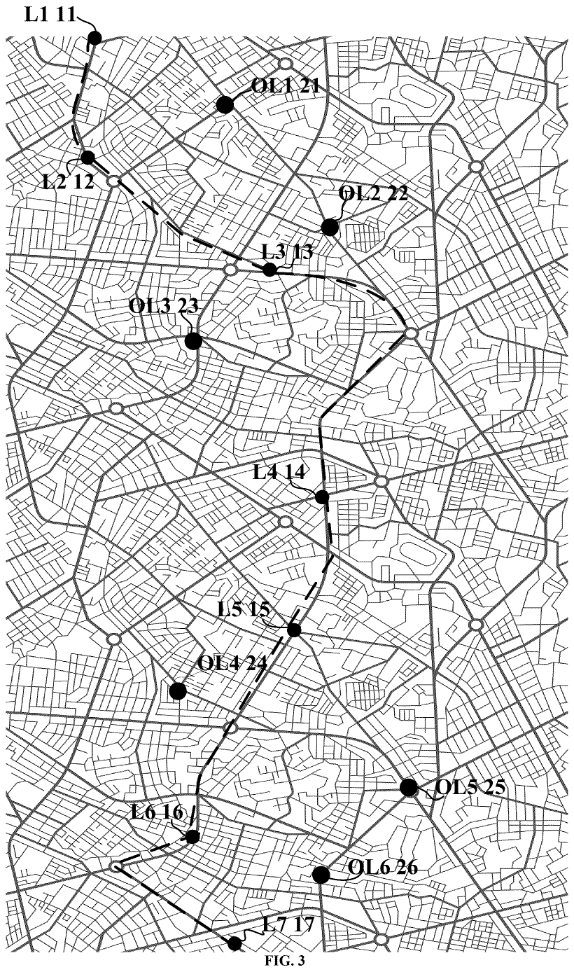

Referring to FIG. 3, a map illustrates an enhanced driving path configuration that includes both planned locations and optional locations to accommodate potential deviations from the planned driving path. The map shows a first location 11 positioned along the planned driving path, corresponding to the first location L1 described in relation to FIG. 2. A second location 12 may be positioned sequentially along the planned driving path, corresponding to the second location L2. The planned driving path may continue through a third location 13, a fourth location 14, a fifth location 15, a sixth location 16, and a seventh location 17, which correspond respectively to the third location L3, the fourth location L4, the fifth location L5, the sixth location L6, and the seventh location L7.

In addition to the planned locations, the map may include optional locations that represent potential deviation points from the planned driving path. A first optional location 21 may be positioned adjacent to a corresponding segment of the planned driving path, providing an alternative route option that the autonomous vehicle may encounter. The first optional location 21 may correspond to a first optional location OL1 that serves as a deviation point from the planned path. A second optional location 22 may be positioned at another deviation point, corresponding to a second optional location OL2. The map may further include a third optional location 23 corresponding to a third optional location OL3, a fourth optional location 24 corresponding to a fourth optional location OL4, a fifth optional location 25 corresponding to a fifth optional location OL5, and a sixth optional location 26 corresponding to a sixth optional location OL6.

The optional locations may be strategically positioned to provide artificial intelligence capabilities when the autonomous vehicle deviates from the planned driving path due to traffic conditions, road closures, navigation changes, or other factors that require route modifications. Each of the first optional location OL1 through the sixth optional location OL6 may be associated with default ensembles that provide autonomous driving capabilities for unplanned locations along alternative routes.

Method 10 may further comprise receiving a default ensemble when the autonomous vehicle encounters situations where a local ensemble compatible to any of the planned locations is not accessible. The default ensemble may provide generalized artificial intelligence capabilities that can address various driving scenarios without being specifically tailored to particular environmental conditions. In some cases, method 10 may include selecting to generate the one or more driving related decision by the default ensemble when a local ensemble compatible to any of the locations is not accessible. The default ensemble may serve as a fallback mechanism that ensures continuous autonomous driving capabilities even when location-specific ensembles are unavailable due to communication issues, system failures, or unexpected route deviations.

The default ensemble may be pre-loaded onto the autonomous vehicle or transmitted from the remote computerized system as a backup artificial intelligence resource. When the autonomous vehicle travels to the first optional location OL1, the second optional location OL2, or any of the other optional locations, the default ensemble may be activated to provide driving related decisions. The default ensemble may contain narrow artificial intelligence agents that are trained to handle a broader range of scenarios compared to the location-specific ensembles, though potentially with reduced specialization for particular environmental conditions.

The non-transitory computer-readable medium may store instructions that, when executed by a processor of an autonomous vehicle, cause the processor to perform operations that further comprise receiving a default ensemble, and selecting to generate the one or more driving related decision by the default ensemble when a local ensemble compatible to any of the locations is not accessible. These operations may enable the autonomous vehicle to maintain autonomous driving capabilities across both planned and unplanned routes, ensuring operational continuity regardless of route deviations or communication disruptions with the remote computerized system.

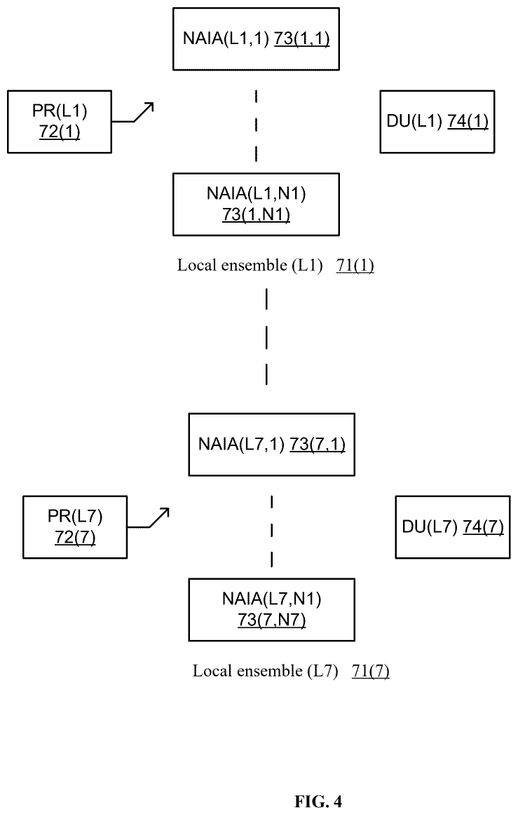

Referring to FIG. 4, a system architecture illustrates local ensembles 71 deployed at different locations along the driving path to provide location-specific artificial intelligence capabilities for autonomous vehicle operations. The system may include a first local ensemble 71(1) that is associated with the first location L1, and a seventh local ensemble 71(7) that is associated with the seventh location L7. Each local ensemble 71 may comprise multiple components that work together to analyze environmental conditions and generate driving related decisions tailored to the specific location and expected scenarios.

The first local ensemble 71(1) may include a local perception router 72(1) labeled as PR(L1) that serves as a routing component for selecting appropriate artificial intelligence agents based on sensed environmental information. The first local ensemble 71(1) may further comprise multiple narrow artificial intelligence agents 73(1,1) through 73(1,N1) labeled as NAIA(L1,1) through NAIA(L1,N1), where N1 represents the number of narrow artificial intelligence agents available within the first local ensemble 71(1). A decision unit 74(1) labeled as DU(L1) may be included in the first local ensemble 71(1) to process outputs from the selected narrow artificial intelligence agents 73 and convert these outputs into driving related decisions.

Similarly, the seventh local ensemble 71(7) may include a local perception router 72(7) labeled as PR(L7) that provides routing functionality for the seventh location L7. The seventh local ensemble 71(7) may comprise multiple narrow artificial intelligence agents 73(7,1) through 73(7,N7) labeled as NAIA(L7,1) through NAIA(L7,N7), where N7 represents the number of narrow artificial intelligence agents available within the seventh local ensemble 71(7). A decision unit 74(7) labeled as DU(L7) may be included in the seventh local ensemble 71(7) to generate driving related decisions based on outputs from the selected narrow artificial intelligence agents 73.

The narrow artificial intelligence agents 73 may be related to the environment by being trained to generate driving related decisions regarding scenarios expected to be faced by the autonomous vehicle within the environment. Each narrow artificial intelligence agent 73 may be specifically trained on data and scenarios that are characteristic of the environmental conditions, traffic patterns, road infrastructure, and driving situations anticipated at the corresponding location. The training process may involve machine learning techniques that enable the narrow artificial intelligence agents 73 to recognize and respond to location-specific driving scenarios with enhanced accuracy and efficiency compared to generalized artificial intelligence systems.

In some cases, the narrow artificial intelligence agents 73 may comprise end to end narrow artificial intelligence agents that process sensed information directly to generate driving related decisions without intermediate processing stages. The end to end narrow artificial intelligence agents may utilize neural network architectures that map sensor inputs directly to control outputs, enabling streamlined processing and reduced computational latency for real-time autonomous driving operations.

Alternatively, the narrow artificial intelligence agents 73 may be implemented as modular architectures with separate perception, prediction, planning, and control components. The perception component may process sensed information to identify and classify environmental elements including road participants, infrastructure, and obstacles. The prediction component may forecast future states and behaviors of identified environmental elements. The planning component may generate trajectory plans and driving strategies based on the predicted environmental states. The control component may convert the planned trajectories into specific vehicle control commands for execution by the autonomous vehicle systems.

The narrow artificial intelligence agents 73 may comprise one or more narrow artificial intelligence agents distilled from one or more reference narrow artificial intelligence agents that are larger than the one or more narrow artificial intelligence agents 73. The distillation process may involve various techniques for reducing the computational complexity and memory requirements of the reference narrow artificial intelligence agents while preserving their decision-making capabilities. Structured channel pruning may be applied to remove redundant or less significant neural network channels, reducing the overall model size and computational requirements. Quantization techniques may be used to reduce the precision of numerical representations within the narrow artificial intelligence agents 73, enabling more efficient storage and processing while maintaining acceptable performance levels.

Knowledge distillation may be employed to transfer learned knowledge from larger reference narrow artificial intelligence agents to smaller narrow artificial intelligence agents 73, enabling the smaller agents to achieve comparable performance with reduced computational resources. Low-rank decomposition techniques may be applied to decompose weight matrices within the narrow artificial intelligence agents 73 into lower-rank representations, reducing memory requirements and computational complexity. Model graph optimization may be performed to streamline the computational graph structure of the narrow artificial intelligence agents 73, eliminating redundant operations and improving processing efficiency.

The local perception router 72 may analyze sensed information received from the autonomous vehicle's sensing systems and determine which narrow artificial intelligence agents 73 within the local ensemble 71 are most appropriate for addressing the identified scenario. The local perception router 72 may evaluate factors including environmental conditions, traffic density, road type, weather conditions, and other relevant parameters to select the narrow artificial intelligence agents 73 that are best suited for the current driving situation. The decision unit 74 may receive outputs from the selected narrow artificial intelligence agents 73 and integrate these outputs to generate comprehensive driving related decisions that address the specific scenario faced by the autonomous vehicle at the current location. An example of a decision unit is the coordinator of U.S. patent application Ser. No. 17/093,442 titled “ENSEMBLE OF NARROW AI AGENTS” filing date Sep. 11, 2020 which is incorporated herein by reference. If only one narrow AI agent is selected then the decision unit 74 is not required to select between outputs.

The non-transitory computer-readable medium may store instructions that, when executed by a processor of an autonomous vehicle, cause the processor to perform operations wherein the narrow artificial intelligence agents are related to the environment by being trained to generate driving related decisions regarding scenarios expected to be faced by the autonomous vehicle within the environment. The stored instructions may further cause the processor to perform operations wherein the narrow artificial intelligence agents comprise end to end narrow artificial intelligence agents, or wherein the narrow artificial intelligence agents comprise one or more narrow artificial intelligence agents distilled from one or more reference narrow artificial intelligence agents that are larger than the one or more narrow artificial intelligence agents.

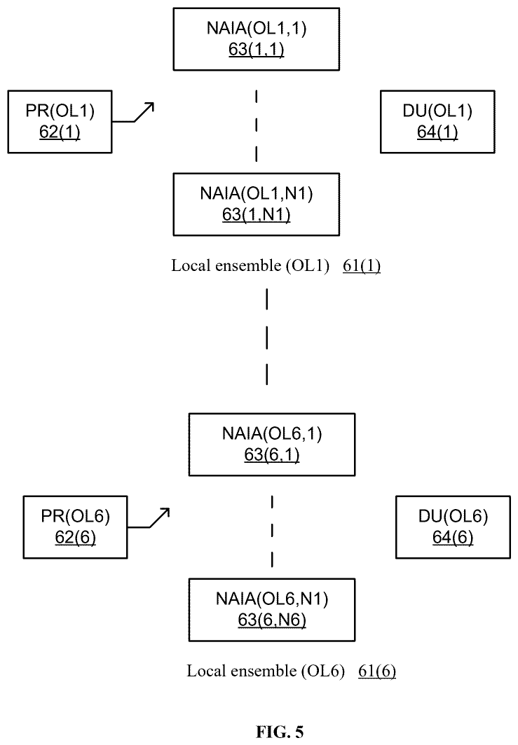

Referring to FIG. 5, a hierarchical representation illustrates optional local ensembles 61 configured to provide artificial intelligence capabilities when the autonomous vehicle deviates from the planned driving path. The optional local ensembles 61 may be deployed at deviation points to ensure continuous autonomous driving functionality when the vehicle encounters unplanned routes or alternative paths. The system may include a first optional local ensemble 61(1) and a sixth optional local ensemble 61(6), each comprising specialized components tailored to handle driving scenarios at their respective deviation locations.

The first optional local ensemble 61(1) may include a local perception router 62(1) labeled as PR(OL1) that serves as a routing component for analyzing environmental conditions and selecting appropriate artificial intelligence agents for the first optional location OL1. The local perception router 62 may be configured to determine a scene based on sensed information received from the autonomous vehicle's sensing systems and evaluate the driving scenario encountered at the deviation location. The first optional local ensemble 61(1) may further comprise multiple narrow artificial intelligence agents 63 including NAIA(OL1,1) 63(1,1) and NAIA(OL1,N1) 63(1,N1), where a first ensemble agent count N1 represents the total number of narrow artificial intelligence agents 63 available within the first optional local ensemble 61(1).

The narrow artificial intelligence agents 63 within the first optional local ensemble 61(1) may be specifically trained to address driving scenarios and environmental conditions that are characteristic of the first optional location OL1. Each narrow artificial intelligence agent 63 may possess specialized capabilities for processing sensed information and generating responses to particular types of driving situations that may be encountered when the autonomous vehicle deviates to the first optional location OL1. The first optional local ensemble 61(1) may also include a decision unit 64(1) labeled as DU(OL1) that receives outputs from the selected narrow artificial intelligence agents 63 and converts these outputs into driving related decisions suitable for execution by the autonomous vehicle's control systems.

With continued reference to FIG. 5, a sixth optional local ensemble 61(6) may follow a similar architectural structure and include a local perception router 62(6) labeled as PR(OL6) that provides routing functionality for the sixth optional location OL6. The local perception router 62 within the sixth optional local ensemble 61(6) may analyze sensed environmental information and determine which narrow artificial intelligence agents 63 are most appropriate for addressing the specific driving scenario encountered at the sixth optional location OL6. The sixth optional local ensemble 61(6) may comprise multiple narrow artificial intelligence agents 63 including NAIA(OL6,1) 63(6,1) and NAIA(OL6,N6) 63(6,N6), where a sixth ensemble agent count N6 represents the total number of narrow artificial intelligence agents 63 available within the sixth optional local ensemble 61(6).

The narrow artificial intelligence agents 63 within the sixth optional local ensemble 61(6) may be trained on data and scenarios that are specific to the environmental conditions and expected driving situations at the sixth optional location OL6. The training process may enable the narrow artificial intelligence agents 63 to recognize and respond to location-specific challenges including traffic patterns, road infrastructure characteristics, and environmental factors that are particular to the sixth optional location OL6. A decision unit 64(6) labeled as DU(OL6) may be included in the sixth optional local ensemble 61(6) to process outputs from the selected narrow artificial intelligence agents 63 and generate driving related decisions that address the specific scenario faced by the autonomous vehicle at the deviation location.

The optional local ensembles 61 may be activated when the autonomous vehicle encounters route deviations due to factors including traffic congestion, road closures, navigation updates, or other circumstances that require departure from the planned driving path. The local perception router 62 within each optional local ensemble 61 may evaluate the sensed information and select one or more narrow artificial intelligence agents 63 based on the identified driving scenario. The selection process may involve analyzing environmental conditions, traffic density, road characteristics, and other relevant factors to determine which narrow artificial intelligence agents 63 possess the most suitable capabilities for the current situation.

The decision unit 64 within each optional local ensemble 61 may integrate outputs from the selected narrow artificial intelligence agents 63 to generate comprehensive driving related decisions that enable safe and efficient autonomous vehicle operation at the deviation location. The driving related decisions may be formatted as control commands or instructions that interface with the autonomous vehicle's control systems to execute appropriate autonomous driving operations including steering adjustments, speed modifications, braking actions, and other maneuvers necessary for navigating the deviation scenario.

In some cases, method 10 may further comprise removing from a memory unit of the vehicle the local ensemble of the location after the vehicle passed the location. This memory management approach may be applied to both the local ensembles 71 associated with planned locations and the optional local ensembles 61 associated with deviation locations. The removal process may enable efficient utilization of the autonomous vehicle's memory resources by maintaining only the artificial intelligence capabilities that are relevant to the current and upcoming locations along the driving path.

The non-transitory computer-readable medium may store instructions that, when executed by a processor of an autonomous vehicle, cause the processor to perform operations wherein the operations further comprise removing from a memory unit of the vehicle the local ensemble of the location after the vehicle passed the location. The memory management operations may ensure that the autonomous vehicle maintains optimal computational performance while preserving sufficient memory capacity for receiving and processing subsequent local ensembles 71 or optional local ensembles 61 as the vehicle progresses along the driving path or encounters additional deviation scenarios.

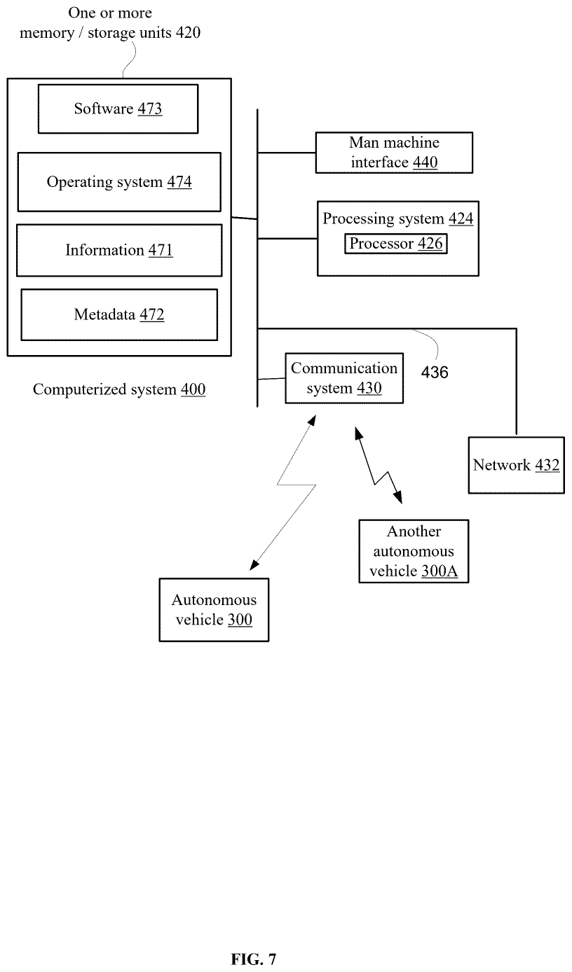

Referring to FIG. 7, a computerized system 400 may provide comprehensive cloud-based architecture that enables advanced computational capabilities for autonomous vehicle operations through location-specific artificial intelligence deployment. The computerized system 400 may maintain simultaneous communication connections with an autonomous vehicle 300 and another autonomous vehicle 300A, demonstrating multi-vehicle processing capabilities that enable coordinated artificial intelligence resource management across multiple connected vehicles. The computerized system 400 may be configured to dynamically generate and distribute local ensembles to connected vehicles based on their respective locations along driving paths.

The computerized system 400 may include a memory unit 420 that maintains various types of data and software components needed for real-time vehicle operations and artificial intelligence resource management. The memory unit 420 may store software 473 that provides core computational algorithms and processing routines for behavioral modeling, artificial intelligence agent management, and ensemble generation processes. The software 473 may include specialized modules for multi-agent coordination, scenario analysis, and location-based artificial intelligence deployment that exceed the computational complexity feasible for on-vehicle processing systems. An operating system 474 may manage fundamental operations of the computerized system 400, coordinating resource allocation, task scheduling, and system-level functions that support real-time processing requirements for multiple autonomous vehicle connections.

The memory unit 420 may also maintain information 471 that includes historical data, learned behavioral patterns, and accumulated knowledge from fleet-wide operations that inform the artificial intelligence capabilities of the computerized system 400. The information 471 may encompass traffic pattern databases, road infrastructure maps, weather condition correlations, and environmental factors that influence vehicle behavior and driving scenarios at different locations. Metadata 472 may provide organizational structures and indexing capabilities that enable efficient retrieval and processing of stored information during real-time operations. The metadata 472 may include data classification schemes, temporal indexing systems, and cross-referencing structures that allow the computerized system 400 to quickly access relevant information for specific traffic scenarios and geographic locations. The memory unit 420 may utilize high-performance storage technologies that provide data access speeds and capacity needed to support simultaneous processing of multiple vehicle scenarios and extensive artificial intelligence agent libraries.

The computerized system 400 may incorporate a man machine interface 440 that provides user interaction capabilities and system monitoring functions for operators and administrators of the cloud-based artificial intelligence system. The man machine interface 440 may enable configuration of system parameters, monitoring of operational status, and review of performance metrics across connected vehicle fleets. Through the man machine interface 440, system operators may access comprehensive dashboards that display real-time processing statistics, ensemble deployment success rates, and system health indicators that ensure optimal performance of the artificial intelligence distribution capabilities. The man machine interface 440 may also provide access to detailed logs and reports that document system decisions, ensemble deployment outcomes, and performance trends that support system optimization initiatives. In some cases, the man machine interface 440 may include visualization tools that allow operators to review specific traffic scenarios, examine decision-making processes of artificial intelligence agents, and validate effectiveness of location-based ensemble strategies.

A processing system 424 may serve as the computational core of the computerized system 400, providing advanced processing capabilities needed to perform complex artificial intelligence operations and resource management for multiple autonomous vehicles simultaneously. The processing system 424 may include a processor 426 that coordinates various computational tasks and manages allocation of processing resources across different vehicle scenarios and artificial intelligence agent requirements. The processor 426 may utilize high-performance computing architectures that enable parallel processing of multiple traffic scenarios and artificial intelligence agent operations, allowing the computerized system 400 to maintain comprehensive libraries of narrow artificial intelligence agents while generating location-specific subsets for individual vehicles. The processing system 424 may incorporate specialized computational units optimized for machine learning algorithms, artificial intelligence agent processing, and real-time data analysis that support sophisticated behavioral modeling and ensemble generation capabilities. In some cases, the processing system 424 may include graphics processing units and other specialized hardware that accelerate mathematical computations involved in artificial intelligence agent training, optimization, and deployment processes.

With continued reference to FIG. 7, a communication system 430 may provide network interface capabilities that enable the computerized system 400 to maintain simultaneous connections with multiple autonomous vehicles and exchange artificial intelligence resources in real-time. The communication system 430 may support various wireless communication protocols and network standards that ensure reliable connectivity across different geographic regions and network infrastructure configurations. Through a communication link 436, the communication system 430 may interface with a network 432 that provides data transmission pathways between the computerized system 400 and connected vehicle fleets. The communication link 436 may incorporate redundancy mechanisms and error correction protocols that maintain data transmission reliability even under challenging network conditions or high traffic loads. The communication system 430 may manage data compression and decompression processes that optimize bandwidth utilization while preserving accuracy and completeness of artificial intelligence ensemble information transmitted to vehicles and operational data received from vehicles.

The computerized system 400 may process and coordinate artificial intelligence resources such that each local ensemble comprises a fraction of narrow artificial intelligence agents accessible to the computerized system 400 during the driving session. The computerized system 400 may maintain comprehensive libraries of narrow artificial intelligence agents that encompass various driving scenarios, environmental conditions, and operational requirements across different geographic regions and road types. When generating local ensembles for specific locations, the computerized system 400 may select subsets of narrow artificial intelligence agents from the comprehensive libraries based on factors including expected scenarios, environmental conditions, and computational constraints of the receiving autonomous vehicle. The fraction of narrow artificial intelligence agents included in each local ensemble may be determined to provide sufficient capabilities for anticipated driving situations while maintaining efficient memory utilization and processing performance on the autonomous vehicle.

The router within each local ensemble may have selection capabilities that are a fraction of overall selection capabilities required to select between the narrow artificial intelligence agents accessible to the computerized system 400 during the driving session. The computerized system 400 may maintain global routing capabilities that encompass comprehensive decision-making processes for selecting among all available narrow artificial intelligence agents based on detailed scenario analysis and environmental assessment. When generating local ensembles, the computerized system 400 may create simplified routing components that possess specialized selection capabilities tailored to the specific narrow artificial intelligence agents included in each local ensemble. The fraction of selection capabilities provided to each router may be optimized to enable efficient scenario-based agent selection while reducing computational overhead and processing complexity on the autonomous vehicle.

Method 10 may further comprise predicting an occurrence of a future miscommunication with the computerized system 400, and sending a future miscommunication indication to the computerized system 400. The autonomous vehicle may monitor communication quality parameters including signal strength, data transmission rates, error rates, and network connectivity status to assess the likelihood of communication disruptions. When the autonomous vehicle detects conditions that may lead to communication failures, the autonomous vehicle may generate predictions regarding potential miscommunication events and transmit these predictions to the computerized system 400. The future miscommunication indication may enable the computerized system 400 to proactively transmit additional local ensembles, default ensembles, or backup artificial intelligence resources to ensure continued autonomous driving capabilities during anticipated communication disruptions.

The non-transitory computer-readable medium may store instructions that, when executed by a processor of an autonomous vehicle, cause the processor to perform operations wherein each local ensemble comprises a fraction of narrow artificial intelligence agents accessible to the computerized system 400 during the driving session. The stored instructions may further cause the processor to perform operations wherein the router has selection capabilities that are a fraction of overall selection capabilities required to select between the narrow artificial intelligence agents accessible to the computerized system 400 during the driving session. Additionally, the non-transitory computer-readable medium may store instructions that cause the processor to perform operations that further comprise predicting an occurrence of a future miscommunication with the computerized system 400, and sending a future miscommunication indication to the computerized system 400.

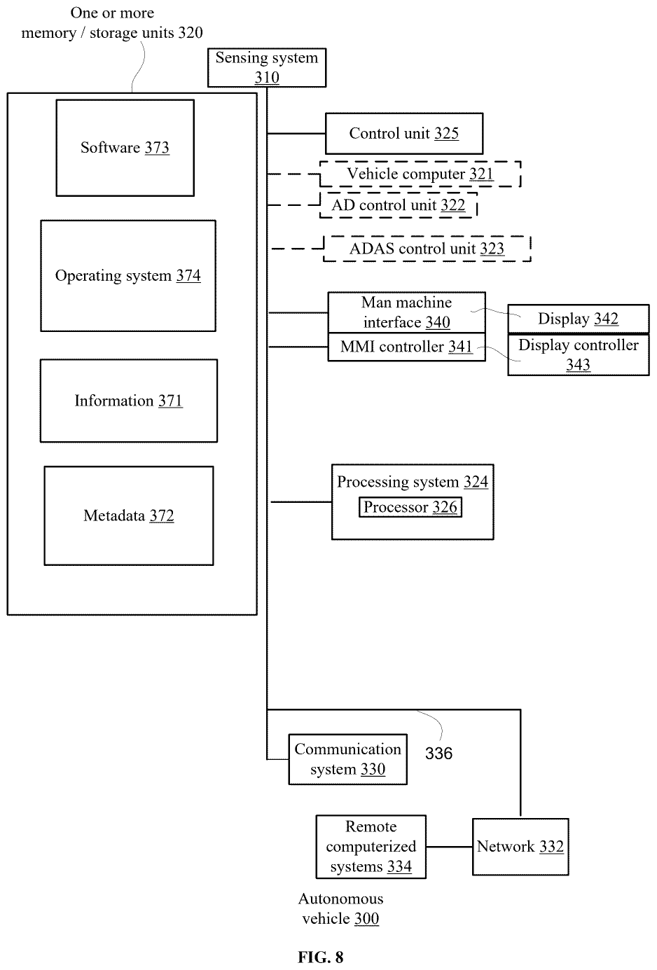

Referring to FIG. 8, an autonomous vehicle 300 may incorporate a comprehensive architecture that enables advanced autonomous driving capabilities while maintaining communication with remote computational resources for location-specific artificial intelligence ensemble deployment. The autonomous vehicle 300 may include a sensing system 310 that serves as a primary environmental awareness component, capturing real-time data about surrounding traffic environments and road conditions. The sensing system 310 may utilize multiple sensor technologies including cameras, lidar, radar, and ultrasonic sensors to generate comprehensive environmental data that supports both local autonomous driving functions and communication with remote artificial intelligence systems. The sensing system 310 may provide continuous monitoring of scene entities, road infrastructure, and environmental conditions that form the foundation for both on-vehicle decision-making and cloud-based ensemble operations.

The sensing system 310 may incorporate sensor fusion algorithms that combine data from the multiple sensor types to generate robust and accurate environmental representations that account for varying weather conditions, lighting scenarios, and sensor performance characteristics. The cameras may provide visual information including lane markings, traffic signs, vehicle identification, and pedestrian detection capabilities. The lidar sensors may generate precise three-dimensional mapping data that enables accurate distance measurements and object detection in various environmental conditions. The radar sensors may provide velocity measurements and object detection capabilities that function effectively in adverse weather conditions including rain, fog, and snow. The ultrasonic sensors may provide close-proximity detection capabilities for parking maneuvers and low-speed navigation scenarios.

The autonomous vehicle 300 may include a memory storage unit 320 that maintains various types of data and software components needed for autonomous driving operations and communication with remote systems. The memory storage unit 320 may store software storage 373 that provides core algorithms and processing routines for autonomous vehicle control, sensor data processing, and communication with cloud-based artificial intelligence systems. The software storage 373 may include specialized modules for perception processing, path planning, vehicle control, and data compression that enable the autonomous vehicle 300 to operate independently while maintaining connectivity with remote computational resources. An operating system storage 374 may manage fundamental operations of the autonomous vehicle 300, coordinating resource allocation, task scheduling, and system-level functions that support real-time autonomous driving operations.

The memory storage unit 320 may also maintain information storage 371 that includes maps, learned driving patterns, and accumulated operational data that inform decision-making processes of the autonomous vehicle 300. The information storage 371 may contain location-specific data, traffic pattern information, and environmental characteristics that support the deployment and utilization of local ensembles received from remote systems. Metadata storage 372 may provide organizational structures and indexing capabilities that enable efficient retrieval and processing of stored information during real-time driving operations. The metadata storage 372 may include classification schemes for local ensembles, temporal indexing for location-based data, and cross-referencing structures that facilitate rapid access to relevant artificial intelligence resources during autonomous driving operations.

A control unit 325 may serve as a central coordination component that manages various subsystems and operational functions of the autonomous vehicle 300. The control unit 325 may include a vehicle computer 321 that provides fundamental vehicle control capabilities including engine management, transmission control, braking systems, and steering mechanisms that enable the autonomous vehicle 300 to execute driving maneuvers and respond to control commands generated by local ensembles. The vehicle computer 321 may interface with existing vehicle systems and electronic control units to provide seamless integration between autonomous driving capabilities and traditional vehicle control functions.

An autonomous driving control unit 322 may manage high-level decision-making processes and path planning functions that enable the autonomous vehicle 300 to navigate complex traffic scenarios and execute autonomous driving maneuvers based on inputs from local ensembles. The autonomous driving control unit 322 may process sensor data from the sensing system 310, generate driving strategies, and coordinate with remote artificial intelligence systems to ensure safe and efficient autonomous vehicle operation. The autonomous driving control unit 322 may receive driving related decisions from local ensembles and translate these decisions into specific control commands for execution by vehicle systems.

The control unit 325 may also incorporate an ADAS control unit 323 that provides advanced driver assistance capabilities and safety monitoring functions that complement the autonomous driving systems. The ADAS control unit 323 may manage various safety features including collision avoidance, lane departure warning, adaptive cruise control, and emergency braking systems that provide additional layers of safety protection during autonomous vehicle operation. The collision avoidance system may monitor surrounding vehicles and obstacles to prevent potential impacts through automatic steering or braking interventions. The lane departure warning system may detect unintended lane departures and provide corrective actions to maintain proper lane positioning. The adaptive cruise control system may automatically adjust vehicle speed to maintain safe following distances from preceding vehicles. The emergency braking system may detect imminent collision scenarios and apply maximum braking force to prevent or mitigate impacts.

The ADAS control unit 323 may operate in coordination with the autonomous driving control unit 322 to provide comprehensive safety coverage and redundant protection mechanisms that enhance overall safety performance of the autonomous vehicle 300. In some cases, the ADAS control unit 323 may serve as a backup system that can assume control functions if primary autonomous driving systems encounter operational difficulties or when local ensembles are unavailable. The control unit 325 may coordinate operations of the vehicle computer 321, the autonomous driving control unit 322, and the ADAS control unit 323 to ensure seamless integration and optimal performance of all vehicle control functions.

A processing system 324 may provide computational capabilities needed to support real-time autonomous driving operations and communication with remote artificial intelligence systems. The processing system 324 may include a processor 326 that executes various software modules and algorithms stored in the memory storage unit 320, enabling the autonomous vehicle 300 to process sensor data, utilize local ensembles, make driving decisions, and coordinate with cloud-based systems. The processor 326 may utilize specialized computing architectures that provide processing speed and computational efficiency needed for real-time autonomous driving applications while managing power consumption and thermal constraints associated with mobile computing environments. The processing system 324 may coordinate with the control unit 325 to ensure computational resources are allocated appropriately across different vehicle functions and that real-time processing requirements are met for both local ensemble operations and remote system communication.

A communication system 330 may enable the autonomous vehicle 300 to maintain connectivity with remote computational resources and exchange artificial intelligence ensembles for location-specific autonomous driving operations. The communication system 330 may support various wireless communication protocols and network standards that ensure reliable connectivity across different geographic regions and network infrastructure configurations. Through a communication link 336, the communication system 330 may interface with a network 332 that provides data transmission pathways between the autonomous vehicle 300 and cloud-based artificial intelligence systems. The network 332 may support high-bandwidth, low-latency communication that enables real-time transmission of local ensemble requests and reception of location-specific artificial intelligence resources from a remote computerized system 334 that provides advanced computational analysis and ensemble generation capabilities.

The communication system 330 may manage data compression and transmission protocols that optimize bandwidth utilization while ensuring timely delivery of local ensembles and operational data exchange with the remote computerized system 334. The communication link 336 may incorporate error correction mechanisms and redundancy protocols that maintain reliable data transmission even under challenging network conditions or when the autonomous vehicle 300 travels through areas with varying signal strength.

The autonomous vehicle 300 may incorporate a man machine interface 340 that provides interaction capabilities between vehicle occupants and autonomous driving systems utilizing local ensembles. The man machine interface 340 may include an interface controller 341 that manages user input processing, system status communication, and interface coordination functions that enable effective human-vehicle interaction during autonomous driving operations with location-specific artificial intelligence capabilities. The interface controller 341 may coordinate with other vehicle systems to provide real-time feedback about autonomous driving status, local ensemble deployment, route planning, and artificial intelligence system operations that keep vehicle occupants informed about operational state of the autonomous vehicle 300.

A display 342 may provide visual information to vehicle occupants including navigation displays, system status indicators, and alerts that communicate operational state and decision-making processes of autonomous driving systems utilizing local ensembles. The display 342 may show information about currently active local ensembles, selected narrow artificial intelligence agents, and driving related decisions generated by location-specific artificial intelligence resources. The display 342 may be managed by a display controller 343 that coordinates presentation of information and ensures visual displays remain current and accurate during autonomous vehicle operation with local ensemble deployment.

Method 10 may further comprise removing from a memory unit of the vehicle the local ensemble of the location after the vehicle passed the location. This memory management process may be implemented by the memory storage unit 320 in coordination with the processing system 324 to optimize utilization of available storage resources. When the autonomous vehicle 300 progresses beyond a specific location along the driving path, the local ensemble associated with that location may be deleted from the memory storage unit 320 to free storage space for subsequent local ensembles. The removal process may be triggered automatically based on location tracking data that indicates when the autonomous vehicle 300 has moved sufficiently far from a location that the associated local ensemble is no longer needed.

The memory management process may enable the autonomous vehicle 300 to maintain optimal computational performance while preserving sufficient memory capacity within the memory storage unit 320 for receiving and processing new local ensembles as the vehicle progresses along the driving path. The removal of local ensembles may be coordinated with the communication system 330 to ensure that new local ensembles are received and stored before previous ensembles are deleted, maintaining continuous availability of location-specific artificial intelligence capabilities.

The deletion may be implemented using memory resource control schemes that provide systematic approaches for managing storage allocation and deallocation within the memory storage unit 320. In some cases, the memory resource control schemes may employ least recently used algorithms that prioritize removal of local ensembles based on temporal access patterns, ensuring that frequently accessed artificial intelligence resources remain available while older or unused ensembles are candidates for deletion. The least recently used approach may maintain access timestamps for each local ensemble and systematically remove ensembles that have not been accessed within predetermined time intervals.

The memory resource control schemes may utilize first-in-first-out management strategies that remove local ensembles in the order they were originally stored, providing predictable memory management behavior that ensures older ensembles are deleted before newer ones regardless of usage patterns. In some aspects, the first-in-first-out approach may be combined with location-based prioritization that considers the autonomous vehicle's current position and planned route to determine which ensembles should be retained or removed based on geographic relevance.

Priority-based memory management schemes may be applied to assign different retention priorities to local ensembles based on factors including ensemble complexity, computational requirements, expected usage frequency, and strategic importance for upcoming driving scenarios. The priority-based schemes may maintain high-priority ensembles in memory storage unit 320 for extended periods while removing lower-priority ensembles more aggressively to optimize storage utilization. In some cases, the priority assignments may be dynamically adjusted based on real-time conditions including traffic patterns, route changes, and communication status with the remote computerized system 334.

Reference counting memory management may be employed to track active usage of local ensembles by different vehicle subsystems and ensure that ensembles are only deleted when no active references exist. The reference counting approach may maintain counters that indicate how many vehicle components are currently utilizing each local ensemble, preventing premature deletion of ensembles that remain in active use by the autonomous driving control unit 322, ADAS control unit 323, or other vehicle systems.

Garbage collection schemes may be implemented to perform periodic memory cleanup operations that identify and remove unused local ensembles, temporary data structures, and fragmented memory segments within the memory storage unit 320.

The garbage collection may operate during periods of reduced computational load to minimize impact on real-time autonomous driving operations while ensuring efficient memory utilization. In some aspects, the garbage collection may employ mark-and-sweep algorithms that identify reachable memory objects and remove unreferenced data structures, or generational collection approaches that manage memory based on object age and usage patterns.

The non-transitory computer-readable medium may store instructions that, when executed by the processor 326 of the autonomous vehicle 300, cause the processor 326 to perform operations that further comprise removing from a memory unit of the vehicle the local ensemble of the location after the vehicle passed the location. The stored instructions may implement automated memory management routines that monitor location progress, evaluate storage utilization, and execute ensemble removal operations to maintain efficient memory usage throughout the autonomous driving session.

The memory management process may enable the autonomous vehicle 300 to maintain optimal computational performance while preserving sufficient memory capacity within the memory storage unit 320 for receiving and processing new local ensembles as the vehicle progresses along the driving path. The removal of local ensembles may be coordinated with the communication system 330 to ensure that new local ensembles are received and stored before previous ensembles are deleted, maintaining continuous availability of location-specific artificial intelligence capabilities.

The non-transitory computer-readable medium may store instructions that, when executed by the processor 326 of the autonomous vehicle 300, cause the processor 326 to perform operations that further comprise removing from a memory unit of the vehicle the local ensemble of the location after the vehicle passed the location. The stored instructions may implement automated memory management routines that monitor location progress, evaluate storage utilization, and execute ensemble removal operations to maintain efficient memory usage throughout the autonomous driving session.

As further shown in FIG. 8, a global ensemble 41 may provide a hierarchical architecture that encompasses comprehensive artificial intelligence capabilities accessible to the remote computerized system 334. The global ensemble 41 may maintain an extensive collection of narrow artificial intelligence agents that serve as a master repository from which location-specific local ensembles are derived. The global ensemble 41 may include a NAIA 1 that represents one of multiple narrow artificial intelligence agents available within the comprehensive artificial intelligence library maintained by the remote computerized system 334.

The global ensemble 41 may further comprise a NAIA(M) 43 that represents additional narrow artificial intelligence agents within the hierarchical structure, where M may indicate the total number or a specific identifier for narrow artificial intelligence agents maintained within the global ensemble 41. The NAIA(M) 43 may possess specialized capabilities for addressing particular driving scenarios, environmental conditions, or operational requirements that may be encountered across various geographic locations and road types. The narrow artificial intelligence agents within the global ensemble 41 may be organized according to their specialized functions, training domains, and applicability to different driving scenarios.

The global ensemble 41 may include a global PR 42 that provides comprehensive routing capabilities beyond the local routers deployed within individual local ensembles. The global PR 42 may maintain extensive selection capabilities that encompass decision-making processes for choosing among all narrow artificial intelligence agents available within the global ensemble 41. The global PR 42 may analyze comprehensive environmental data, traffic scenarios, road infrastructure characteristics, and operational requirements to determine optimal combinations of narrow artificial intelligence agents for specific locations and driving conditions. The routing capabilities of the global PR 42 may exceed the computational complexity and decision-making scope of local perception routers by incorporating broader contextual information and cross-scenario analysis capabilities.

The global PR 42 may evaluate factors including historical traffic patterns, seasonal variations, infrastructure changes, and fleet-wide operational data to generate sophisticated routing decisions that optimize artificial intelligence resource allocation across multiple autonomous vehicles and driving scenarios. The comprehensive routing capabilities may enable the global PR 42 to anticipate future artificial intelligence requirements based on planned routes, predicted traffic conditions, and environmental forecasts. The global PR 42 may coordinate with the processing system 424 and the processor 426 of the computerized system 400 to perform complex analysis operations that determine which subsets of narrow artificial intelligence agents should be included in location-specific local ensembles.

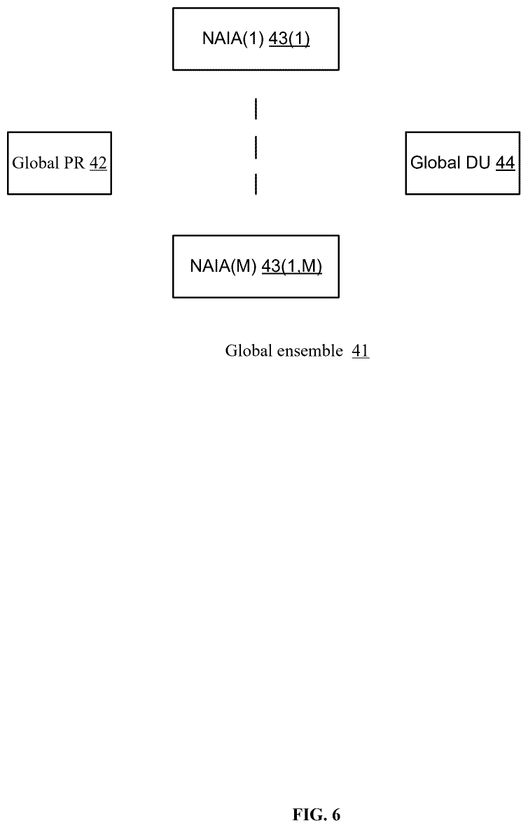

With continued reference to FIG. 6, the global ensemble 41 may incorporate a global DU 44 that provides comprehensive decision-making capabilities from which local decision units are generated for deployment within individual local ensembles. The global DU 44 may maintain extensive decision-making algorithms and processing routines that encompass the full range of autonomous driving scenarios and operational requirements supported by the remote computerized system 334. The global DU 44 may serve as a master decision-making component that possesses comprehensive knowledge and processing capabilities for converting outputs from narrow artificial intelligence agents into driving related decisions across various environmental conditions and driving scenarios.

The global DU 44 may generate simplified decision-making components that are tailored to specific locations and included within local ensembles transmitted to autonomous vehicles. The local decision units derived from the global DU 44 may possess specialized decision-making capabilities that are optimized for the particular narrow artificial intelligence agents and expected scenarios associated with specific locations along driving paths. The derivation process may involve extracting relevant decision-making algorithms, processing routines, and conversion mechanisms from the global DU 44 that are appropriate for the environmental conditions and operational requirements of individual locations.

The global DU 44 may coordinate with the global PR 42 to ensure that local decision units are properly matched with the narrow artificial intelligence agents selected for each local ensemble. The coordination process may involve analyzing the capabilities and output formats of selected narrow artificial intelligence agents to generate compatible decision-making components that can effectively process and integrate outputs from multiple narrow artificial intelligence agents within local ensembles. The global DU 44 may maintain libraries of decision-making templates and processing algorithms that can be customized and optimized for different combinations of narrow artificial intelligence agents and operational scenarios.

The hierarchical organization of the global ensemble 41 may enable the remote computerized system 334 to maintain comprehensive artificial intelligence capabilities while generating efficient location-specific subsets for deployment to autonomous vehicles. The global ensemble 41 may serve as a centralized resource that supports multiple autonomous vehicles simultaneously by providing customized local ensembles that are derived from the comprehensive collection of narrow artificial intelligence agents, routing capabilities, and decision-making components maintained within the global architecture.

The global ensemble 41 may alternatively be organized without a single global PR 42 or global DU 44, instead incorporating one or more regional perception routers and decision units that provide intermediate-level capabilities between local and global scope. In some cases, the remote computerized system 334 may deploy multiple regional perception routers that are each responsible for specific geographic regions, road network types, or environmental condition categories. These regional perception routers may possess routing capabilities that exceed those of local perception routers while maintaining more focused specialization compared to a comprehensive global routing system.

The regional perception routers may be configured to handle artificial intelligence agent selection for clusters of related locations that share similar environmental characteristics, traffic patterns, or infrastructure configurations. In some aspects, each regional perception router may maintain specialized knowledge about particular geographic areas, enabling more nuanced decision-making for narrow artificial intelligence agent selection within their designated regions. The regional approach may enable the remote computerized system 334 to optimize computational resource allocation by distributing routing responsibilities across multiple specialized components rather than centralizing all routing functions within a single global component.

Similarly, the global ensemble 41 may incorporate one or more regional decision units that provide decision-making capabilities for specific operational domains or geographic areas. The regional decision units may possess specialized algorithms and processing routines that are tailored to particular types of driving scenarios, environmental conditions, or vehicle operational requirements encountered within their designated regions. In some cases, the regional decision units may be optimized for specific road types including urban environments, highway systems, rural areas, or specialized infrastructure configurations such as construction zones or complex intersections.

The regional decision units may coordinate with corresponding regional perception routers to ensure compatibility between agent selection processes and decision-making capabilities within each regional domain. This coordination may involve maintaining synchronized libraries of decision-making templates and processing algorithms that are specifically designed for the narrow artificial intelligence agents typically selected by the associated regional perception router. The regional approach may enable more efficient processing and reduced computational complexity compared to maintaining comprehensive global decision-making capabilities that encompass all possible scenarios and operational requirements.

The hierarchical organization may include multiple levels of perception routers and decision units, with local components deployed within individual local ensembles, regional components managing clusters of related locations, and potentially higher-level components that coordinate between regional systems. This multi-tiered architecture may provide flexibility in resource allocation and enable the remote computerized system 334 to adapt the organizational structure based on operational requirements, computational constraints, and geographic distribution of autonomous vehicle fleets.

A number of implementations have been described. Nevertheless, it will be understood that various modifications may be made without departing from the spirit and scope of the disclosure. Accordingly, other implementations are within the scope of the following claims.

In the foregoing specification, the invention has been described with reference to specific examples of embodiments of the invention. It will, however, be evident that various modifications and changes may be made therein without departing from the broader spirit and scope of the invention as set forth in the appended claims. The specifications and drawings are, accordingly, to be regarded in an illustrative rather than in a restrictive sense.

Those skilled in the art will recognize that the boundaries between logic blocks are merely illustrative and that alternative embodiments may merge logic blocks or circuit elements or impose an alternate decomposition of functionality upon various logic blocks or circuit elements. Thus, it is to be understood that the architectures depicted herein are merely exemplary, and that in fact many other architectures may be implemented which achieve the same functionality.

Those skilled in the art will recognize that boundaries between the above-described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

Any arrangement of components to achieve the same functionality is effectively “associated” such that the desired functionality is achieved. Hence, any two components herein combined to achieve a particular functionality may be seen as “associated with” each other such that the desired functionality is achieved, irrespective of the underlying architecture or intermedial components. Likewise, any two components so associated can also be viewed as being “operably connected,” or “operably coupled,” to each other to achieve the desired functionality.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

It is appreciated that various features of the embodiments of the disclosure which are, for clarity, described in the contexts of separate embodiments may also be provided in combination in a single embodiment. Conversely, various features of the embodiments of the disclosure which are, for brevity, described in the context of a single embodiment may also be provided separately or in any suitable sub-combination.

It will be appreciated by persons skilled in the art that the embodiments of the disclosure are not limited by what has been particularly shown and described hereinabove. Thus, the scope of the embodiments of the disclosure is defined by the appended claims and equivalents thereof. While certain features of the disclosure have been illustrated and described herein, many modifications, substitutions, changes, and equivalents will now occur to those of ordinary skill in the art. It is therefore to be understood that the appended claims are intended to cover all such modifications and changes as fall within the true spirit of the invention.

The different figures illustrates examples of units and/or software and/or information items and/or steps and/or components. These examples are provided for brevity of explanation. At least one of the units and/or software and/or information items and/or steps and/or components is optional or mandatory.

One or more method steps may be executed by artificial intelligence entities and/or a machine learning entity. A behavioral agent may be an artificial intelligence entity.

Artificial intelligence is used in relation to machines that mimic human intelligence and human cognitive functions like learning and problem solving. There are three types of artificial intelligence that include artificial super intelligence, artificial narrow intelligence and artificial general intelligence. Machine learning is a subset of artificial intelligence that allows for optimization. Deep machine learning is a subset of machine learning that uses larger datasets for training and learns in a different manner than not deep machine learning. Neural networks are a subset of machine learning and are used for implementing deep learning.

Any reference to an artificial intelligence model should be applied mutatis mutandis to an artificial intelligence process.

Any reference in the application to any of the terms “artificial intelligence”, “machine learning”, “deep learning” or “neural network” should be applied mutatis mutandis to any other term of “artificial intelligence”, “machine learning”, “deep learning” or “neural network”. For example-any reference to a neural network should be applied mutatis mutandis to artificial intelligence and/or should be applied mutatis mutandis to “machine learning”, and/or should be applied mutatis mutandis to “deep learning”.

A number of implementations have been described. Nevertheless, it will be understood that various modifications may be made without departing from the spirit and scope of the disclosure. Accordingly, other implementations are within the scope of the following claims.

Any combination of any steps of any method illustrated in the specification and/or drawings may be provided. Any combination of any subject matter of any of claims may be provided. Any combinations of systems, units, components, processors, sensors, illustrated in the specification and/or drawings may be provided. Any combination of any module or unit listed in any of the figures, any part of the specification and/or any claims may be provided.

Any reference in the specification to a method should be applied mutatis mutandis to a device or system capable of executing the method and/or to a non-transitory computer readable medium that stores instructions for executing the method. Any reference in the specification to a system or device should be applied mutatis mutandis to a method that may be executed by the system, and/or may be applied mutatis mutandis to non-transitory computer readable medium that stores instructions executable by the system.

Any reference in the specification to a non-transitory computer readable medium should be applied mutatis mutandis to a device or system capable of executing instructions stored in the non-transitory computer readable medium and/or may be applied mutatis mutandis to a method for executing the instructions.

In the foregoing specification, the invention has been described with reference to specific examples of embodiments of the invention. It will, however, be evident that various modifications and changes may be made therein without departing from the broader spirit and scope of the invention as set forth in the appended claims. The specifications and drawings are, accordingly, to be regarded in an illustrative rather than in a restrictive sense.

Those skilled in the art will recognize that the boundaries between logic blocks are merely illustrative and that alternative embodiments may merge logic blocks or circuit elements or impose an alternate decomposition of functionality upon various logic blocks or circuit elements. Thus, it is to be understood that the architectures depicted herein are merely exemplary, and that in fact many other architectures may be implemented which achieve the same functionality.

Those skilled in the art will recognize that boundaries between the above-described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

Any arrangement of components to achieve the same functionality is effectively “associated” such that the desired functionality is achieved. Hence, any two components herein combined to achieve a particular functionality may be seen as “associated with” each other such that the desired functionality is achieved, irrespective of the underlying architecture or intermedial components. Likewise, any two components so associated can also be viewed as being “operably connected,” or “operably coupled,” to each other to achieve the desired functionality.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

It is appreciated that various features of the embodiments of the disclosure which are, for clarity, described in the contexts of separate embodiments may also be provided in combination in a single embodiment. Conversely, various features of the embodiments of the disclosure which are, for brevity, described in the context of a single embodiment may also be provided separately or in any suitable sub-combination.

It will be appreciated by persons skilled in the art that the embodiments of the disclosure are not limited by what has been particularly shown and described hereinabove. Thus, the scope of the embodiments of the disclosure is defined by the appended claims and equivalents thereof. While certain features of the disclosure have been illustrated and described herein, many modifications, substitutions, changes, and equivalents will now occur to those of ordinary skill in the art. It is therefore to be understood that the appended claims are intended to cover all such modifications and changes as fall within the true spirit of the invention.

1. A method for agentic artificial intelligence agents based driving of an autonomous vehicle, method comprising:
for each location of multiple locations being passed by the autonomous vehicle that follows a driving path:
receiving, from a remote computerized system and by a computerized unit of the autonomous vehicle, a local ensemble that is associated with an environment of the autonomous vehicle once the autonomous vehicle is located at the location, wherein the local ensemble comprises narrow artificial intelligence agents related to the environment and a router configured to select one or more of the narrow artificial intelligence agents based on at least information regarding the environment;
feeding the local ensemble with sensed information regarding the environment;
identifying, by the router and based on the sensed information, a scenario faced by the autonomous vehicle;
selecting, by the router, one or more selected narrow artificial intelligence agents associated with the scenario;
sending the sensed information to the one or more selected narrow artificial intelligence agents;
generating, by the one or more selected narrow artificial intelligence agents, one or more driving related decision; and
triggering an execution of one or more autonomous driving operations based on the one or more driving related decision.

2. Method of claim 1, wherein each local ensemble comprises a fraction of narrow artificial intelligence agents accessible to the remote computerized system during the driving session.

3. Method of claim 2, wherein the router has selection capabilities that are a fraction of overall selection capabilities required to select between the narrow artificial intelligence agents accessible to the remote computerized system during the driving session.

4. Method of claim 1, further comprising receiving a default ensemble, and selecting to generate the one or more driving related decision by the default ensemble when a local ensemble compatible to any of the locations is not accessible.

5. Method of claim 1, further comprising predicting an occurrence of a future miscommunication with the remote computerized system, and sending a future miscommunication indication to the remote computerized system.

6. Method of claim 1, wherein the narrow artificial intelligence agents are related to the environment by being trained to generate driving related decisions regarding scenarios expected to be faced by the autonomous vehicle within the environment.

7. Method of claim 1, wherein at least some of the multiple locations are spaced apart by tens of meters from each other.

8. Method of claim 1, further comprising removing from a memory unit of the vehicle the local ensemble of the location after the vehicle passed the location.

9. Method of claim 1, wherein the narrow artificial intelligence agents comprise end to end narrow artificial intelligence agents.

10. Method of claim 1, wherein the narrow artificial intelligence agents comprise one or more narrow artificial intelligence agents distilled from one or more reference narrow artificial intelligence agents that are larger than the one or more narrow artificial intelligence agents.

11. A non-transitory computer-readable medium storing instructions that, when executed by a processor of an autonomous vehicle, cause the processor to perform operations comprising:
for each location of multiple locations being passed by the autonomous vehicle that follows a driving path:
receiving, from a remote computerized system and by a computerized unit of the autonomous vehicle, a local ensemble that is associated with an environment of the autonomous vehicle once the autonomous vehicle is located at the location, wherein the local ensemble comprises narrow artificial intelligence agents related to the environment and a router configured to select one or more of the narrow artificial intelligence agents based on at least information regarding the environment;
feeding the local ensemble with sensed information regarding the environment;
identifying, by the router and based on the sensed information, a scenario faced by the autonomous vehicle;
selecting, by the router, one or more selected narrow artificial intelligence agents associated with the scenario;
sending the sensed information to the one or more selected narrow artificial intelligence agents;
generating, by the one or more selected narrow artificial intelligence agents, one or more driving related decision; and
triggering an execution of one or more autonomous driving operations based on the one or more driving related decision.

12. The non-transitory computer-readable medium of claim 11, wherein each local ensemble comprises a fraction of narrow artificial intelligence agents accessible to the remote computerized system during the driving session.

13. The non-transitory computer-readable medium of claim 12, wherein the router has selection capabilities that are a fraction of overall selection capabilities required to select between the narrow artificial intelligence agents accessible to the remote computerized system during the driving session.

14. The non-transitory computer-readable medium of claim 11, wherein the operations further comprise receiving a default ensemble, and selecting to generate the one or more driving related decision by the default ensemble when a local ensemble compatible to any of the locations is not accessible.

15. The non-transitory computer-readable medium of claim 11, wherein the operations further comprise predicting an occurrence of a future miscommunication with the remote computerized system, and sending a future miscommunication indication to the remote computerized system.

16. The non-transitory computer-readable medium of claim 11, wherein the narrow artificial intelligence agents are related to the environment by being trained to generate driving related decisions regarding scenarios expected to be faced by the autonomous vehicle within the environment.

17. The non-transitory computer-readable medium of claim 11, wherein at least some of the multiple locations are spaced apart by tens of meters from each other.

18. The non-transitory computer-readable medium of claim 11, wherein the operations further comprise removing from a memory unit of the vehicle the local ensemble of the location after the vehicle passed the location.

19. The non-transitory computer-readable medium of claim 11, wherein the narrow artificial intelligence agents comprise end to end narrow artificial intelligence agents.

20. The non-transitory computer-readable medium of claim 11, wherein the narrow artificial intelligence agents comprise one or more narrow artificial intelligence agents distilled from one or more reference narrow artificial intelligence agents that are larger than the one or more narrow artificial intelligence agents.
